(19) United States
(12) Patent Application Publication
(10) Pub. No.: US 2010/0070610 A1
(43) Pub. Date: Mar. 18, 2010

(54) System and method for the distribution of digital media

(76) Inventor: David B. Buttars, Park City, UT (US)

Correspondence Address: DAVID B. BUTTARS, 8774 GORGOZA DR, PARK CITY, UT, 84098, US

(21) Appl. No.: 12/150,228

(22) Filed: Apr. 25, 2008

(51) Int. Cl. G06F 15/16; G06F 3/048

(52) U.S. Cl. 709/219; 715/763

(57) ABSTRACT

The present invention comprises systems and methods for the distribution of digital media, programs, works and other data (Content). One embodiment of the invention relates to a portable, processor-enabled, non-volatile memory storage device (Storage Device) used to store and transport Content, a processor-enabled playback device (Playback Device) that interfaces with the Storage Device to view Content stored on the Storage Device, and a freestanding, affixed, and/or integrated kiosk device (Kiosk Device) with an independent, on-board drive array or arrays, or a Local Area Network-connected drive array or arrays, or other large capacity data storage memory structures (Drive Arrays) used to access and load Content to the Storage Device. In one embodiment, the Kiosk Device has access to several million Content files on a large number of Drive Arrays. In one embodiment, the Playback Device contains the same functionality as a Kiosk Device, accessing Drive Arrays via the Internet.

### CROSS-REFERENCE TO RELATED U.S. PATENT DOCUMENTS

This is a Regular Nonprovisional Utility Patent Application under 35 U.S.C section 111(a). The entire disclosure of prior application Ser. No. 11/161,271 filed Jul. 28, 2005 and published Jan. 10, 2008, Publication no.: US 2008/008456 A1 is herein incorporated by reference.

Additionally, the entire disclosures of previously filed Provisional Utility Patent Application per 35 U.S.C. 111(b), Nos. 60/914,280, 60/914,282, 60/914,283 and 60/914,286 inclusive.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

As used in this description and in the appended claims, the word ‘Content’ means; all digital data, including but not limited to motion pictures, audio, musical works, video, video games, multi-media, interactive media, data files, programs and other works stored as digital data files

1. Field of the Invention

The invention relates to a system and method for the distribution, storage, and playback of digital media.

2. Background

When a motion picture is released to the public it often follows a release schedule wherein it is release to the cinema market first, then after some period of time, it is released to optical disc (DVD, VCD, Blu-Ray, etc), and after another period of time it is released to cable television. Prior to release to optical disc, it is digitally encoded from it's original film or digital format to the format required for the intended optical disc. This digital file is then used to create a “master” optical disc, which is in-turn used to create optical discs for distribution. Both the production and distribution of these optical discs is relatively expensive, and so only motion pictures that are expected to create a significant return on the costs of production and distribution are released on optical disc. As a result, a vast quantity of motion pictures and other Content are never released to optical disc and they are left to languish in the archives of the Content owner, only generating occasional revenue through airings on broadcast or cable television.

In the past decade, strong movements to distribute motion pictures via the Internet have been made, but have not seen massive success due to core liabilities to Internet delivery. First and foremost Internet delivery is restricted due to overall capacity of the Internet infrastructure itself. The switching and routing capacity provided by the telecom providers is not capable of supporting wide-spread downloading of files the size of movies, particularly at higher definitions supported by DVD and Blu-Ray. As an example, Blockbuster Video rents on average approximately 40 million movies every Friday night. If these were suddenly converted to Internet downloads over that same 6-hour period, the data-load on the switching and routing infrastructure would literally bring the Internet to a grinding halt. This issue is not considered a permanent problem, but it will take many years to increase the capacity of the entire Internet infrastructure to accommodate these types of volumes. In addition to the infrastructure issues, Content security is a significant issue with Internet distribution models because the Content is generally downloaded to a Personal Computer (PC), and as a result, just like DVDs, the protection scheme is available for infinite scrutiny and analysis by dedicated hackers until they decipher the protection scheme. Also, due to inherent frailties in the dominant Operating System (OS), protection schemes that rely on any of the OS resources become subject to those same frailties. As a result of the risks associated with these issues, the Content selection available through the Internet is limited as Content owners choose to retain high-value Content to lower risk formats.

Cable Television services have offered both programmed and “on-demand” movie distribution, as well as a small amount of video game distribution for many years. Cable offers roughly the same quality levels as optical discs but must be viewed from a cable box specific to that provider. The “on-demand” selection of Content is quite restricted due to infrastructure costs, and the viewing experience is limited due to the inability of the cable system to provide for additional features that are readily available on optical disc, as optical discs can store a variety of digital files for access at any time. Security is another concern with Cable distribution. Cable does provide some level of security, simply due to the proprietary nature of the boxes, and the lack of readily available interfaces into these boxes. However, despite the relative security of these boxes, several illicit products are available to enable copying of content from Cable boxes from all manufacturers, and hence content owners tend to release to Cable at the same time as they release to DVD, and with the same understanding that piracy is inevitable once released to that format.

Despite the immense potential for digital formatting to improve the efficiency of motion picture distribution, the challenges of data-volume and security have kept it from fulfilling its full potential.

### BRIEF DESCRIPTION OF THE DRAWINGS

FIG. 1 is a block diagram of a system architecture that can be used with an embodiment of the invention.

FIG. 2 is a block diagram of a Storage Device that can be used with an embodiment of the invention.

FIG. 3 is a block diagram of a “head-end” system that can be used to support an embodiment of the invention.

FIG. 4 is a block diagram showing functional components of an embodiment of the invention.

### DETAILED DESCRIPTION OF INVENTION

### Preferred Embodiment

The present invention comprises a system and method for the distribution, storage, and playback of motion pictures, audio, video, multi-media, interactive media, data files, programs and other works stored as digital data files (Content). Because the current models for digital media distribution are either highly insecure for the Content owner, or require the consumer of the Content to give up core value propositions already enjoyed through the current models. The system and method in this invention provide for significantly increased security of Content while providing increased accessibility and usability to the user.

In one embodiment, a network of freestanding, affixed, and/or integrated kiosk devices (Kiosk Device) with independent, on-board drive arrays, or Local Area Network-connected drive arrays, or other large capacity data storage memory structures (Drive Arrays, containing any number of encoded, encrypted Content files is deployed across a geographical area in locations accessible to consumers who acquire a compatible processor-enabled, non-volatile memory storage device (Storage Device) and a compatible processor-enabled playback device (Playback Device). In this embodiment after a user acquires a Storage Device and a Playback Device, the user sets up a user account in the system head-end and defines the usage parameters of the Storage Device and Playback Device. These parameters include but are not limited to ratings, genres, spending limits, and other use parameters available to the user of the Storage Device and/or Playback Device. The user then defines the initial user profile in the user account and defines the initial parameters of the user profile including but not limited to favorite genres, actors, directors, eras, age, sex, interests, and any other parameters that are, or may be included in the user profile.

In this embodiment, all data associated with the usage of the Storage Device, viewing of Content files on a Playback Device, usage of the Kiosk Device, and all other interactions with the system are collected and aggregated in the user profile in the user account to continually evolve and grow the user profile to more fully define the preferences of that user in the system, creating an increasingly personalized experience over time.

In this embodiment the user connects the Storage Device to the Kiosk Device and is presented with a Graphic User Interface (GUI) wherein the user may browse available Content files from the Content library on the Drive Arrays, view trailers, advertisements, view promotions, manage elements of their user account, purchase temporary or permanent license objects for Content files to be loaded to their Storage Device and conduct other actions or transactions as are or become advantageous to conduct at the Kiosk Device. In one embodiment, the user may search for a specific Content file by some number of available meta-data including, but not limited to title or portion of title, genres, actors, directors, date ranges, producers, studios, or any other meta-data that is, or may become available. In one embodiment, the user may request a specific Content file not found in the Content library stored on the Drive Arrays, and once that Content file becomes available it is loaded to the Drive Array on that Kiosk Device via the Internet, and a notification is sent to the user via email, IM, SMS, text, phone, or any other method that is now, or may become available.

In one embodiment, when a user selects a Content file for loading to their Storage Device, the Kiosk Device generates an encrypted License Object to associate with that Content file that contains the use and viewing permissions and parameters for that Content file including duration of the license based on factors including, but not limited to date, time, number of viewing sessions, options during viewing, and any other parameters that are, or may become advantageous to implement. In this embodiment, the Kiosk Device transfers the Content file encryption keys to the Storage Device along with the Content file and License Object via a secured link to the Storage Device. In one embodiment, the Kiosk Device references the user profile on the Storage Device and selects trailers to accompany the Content file that have correlation with the data in the user profile, thus creating highly personalized trailers for each Content file loaded to the Storage Device. In this embodiment, the Kiosk Device may also select advertisements, promotions, and other offers or content to be loaded to the Storage Device based on the data in the user profile. As the user continues to use the Storage Device, Playback Device, and Kiosk Device data associated with the usage of these devices, viewing of Content files, and all other interactions with the system are collected and aggregated in the user account to continually evolve and grow the user profile so that the user profile creates an increasingly personalized experience over time.

In one embodiment, a plurality of Storage Devices of varying memory capacities and features are available to the user for purchase based on the user's desired use. In one embodiment a Storage Device may be capable of holding hundreds of high-definition, feature length motion pictures, while a less expensive Storage Device may only be able to hold one or two of the same Content files. In this embodiment, by moving the License Objects associated with the Content files, the user may delete Content files from a Storage Device, add Content files to a Storage Device, move Content files from one Storage Device to another, and transfer Content files from one user account to another user account. This embodiment preserves the flexibility enjoyed by users of optical discs in the current industry where they may move the content from user to user with relative ease, while preserving the integrity and licensing of the Content.

In one embodiment, a user can move monetary value from a credit card, debit card, or other electronically-enabled monetary account to any Storage Device registered to that user account. The user can initiate this action from a Kiosk Device, a Kiosk-enabled Playback Device, a personal computer, or any other interface that is, or becomes available to the user to access the user account. Subsequently, the monetary value assigned to the Storage Device may be decremented and used to purchase License Objects at a Kiosk Device.

In one embodiment, the user connects the Storage Device to a Playback Device to view selected Content files. The Playback Device is connected to, or may be embedded in a viewing screen such as a television, LCD panel, Plasma screen, projection screen, monitor, and any other viewing screen that may become compatible with a Playback Device. In this embodiment, the Playback Device authenticates the Storage Device and then accesses the user profile to identify the user and apply any applicable parameters to the Playback Device. The GUI on the Playback Device provides options for viewing Content, managing Content, managing the user profile or user account, and any other options available to the user based on the data in the user profile. When a Content file is selected for viewing, the Playback Device decrypts the License Object and applies the use parameters for the Content file, and then decrypts the Content file for viewing as it streams from the Storage Device. In one embodiment, if during a viewing session a Storage Device is removed from the Playback Device prior to the conclusion of a Content file, the Playback Device records to the Storage Device the frame-set of the Content file where the viewing session was interrupted. Upon re-connecting the Storage Device to a Playback Device, the Storage Device starts the interrupted viewing session of the Content file some number of frames prior to the point at which it was interrupted ensuring that the user doesn't miss any of the Content.

In this embodiment, upon conclusion of the viewing session of a Content file, the Playback Device displays a menu of options offering options including but not limited to extending a temporary License Object, converting a temporary License Object to a permanent License Object, obtaining License Objects for similar or serialized Content, leaving feedback to an online community regarding the Content, and any other menu options that may be developed and implemented to enhance the user experience. In this embodiment, whether the Storage Device is connected to a Playback Device, a Kiosk Device, or not connected to any device at all, at the expiration of a License Object, the processor on board the Storage Device erases the sectors of the memory containing the corresponding Content file thus completely deleting the Content from the Storage Device.

### DETAILED DESCRIPTION OF THE INVENTION

### Written Description Integrating the Drawings

An organization of systems and methods for the distribution of media in digital form is described. In the following description, numerous specific details are set forth in order to provide a thorough understanding of the invention. It will be apparent, however, to one skilled in the art, that the invention may be practiced without these specific details. In other instances, well-known features have not been described in detail in order not to obscure the invention.

One embodiment uses a Kiosk Device with Drive Arrays loaded with Content files of motion pictures for rental or purchase by users with compatible Storage Devices. The invention is, however, equally applicable to other types of Content files, including musical recordings, computer software (including computer games, simulations and virtual environments), interactive programs, video recordings, multi-media programs, etc.

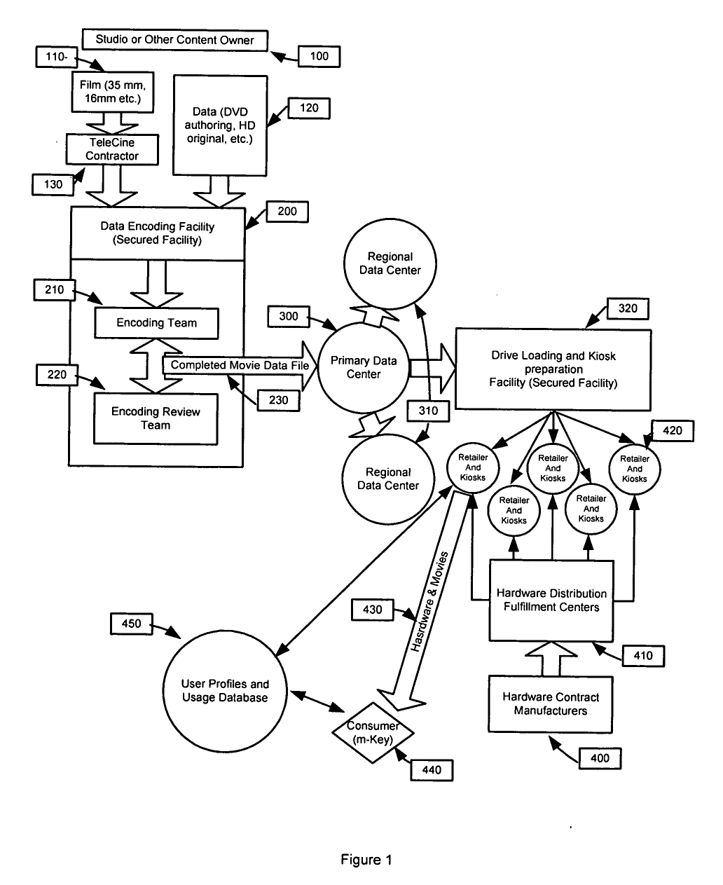

FIG. 1 shows and example of the system architecture that may be used in an embodiment of the invention. Content is received from a Studio or Content Owner (100) in either Film (110), or digital format (120). If received in film, it is converted to digital format through a Tele Cine service (130). Once the Content is in digital form, it is delivered to a secured Data Encoding Facility (200) where an Encoding Team (210) applies encoding to the Content, the encoding process is verified by an Encoding Review Team (220) and once certified, the Completed Data File (230) is delivered to the Primary Data Center (300), and subsequently Kiosk Drives (320) or to Regional Data Centers (310). Storage Devices and Playback Devices are manufactured at CEM facilities (400) and distributed through a variety of distribution relationships (410), to retail facilities (420), and from there to the Consumer (440) through a variety of retail channels (430). Data regarding customer use patterns, as well as any attempts at hacking the system are aggregated and tracked using Usage Databases (450), and that data is pushed back to the Kiosks (420) should a Storage Device show hacking patterns.

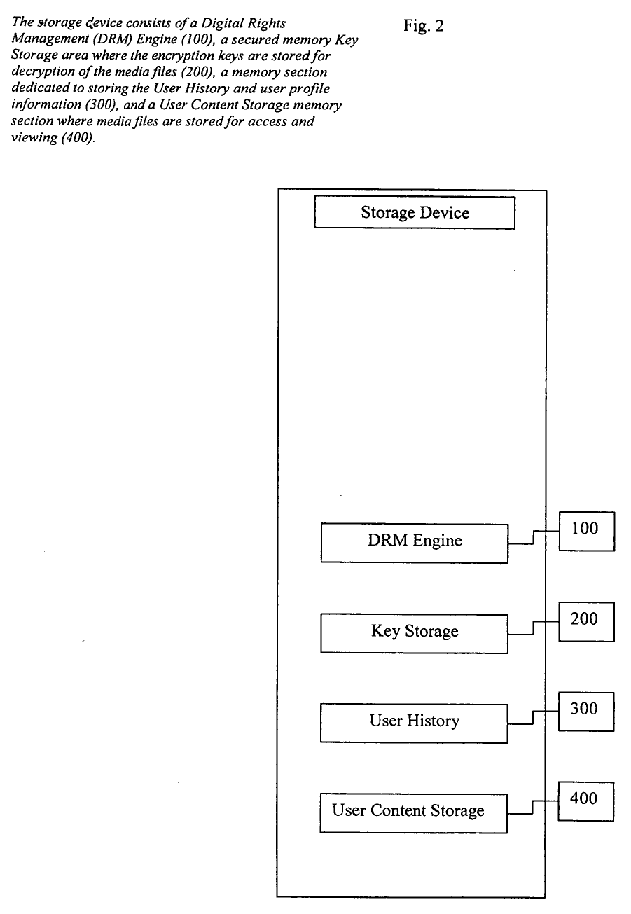

FIG. 2 shows a high-level example of the functional component architecture of a Storage Device used in an embodiment of the invention. After authentication with either a Kiosk Device or Playback Device, the Storage Device initiates a Digital Rights Management (DRM) engine (100) which validates the encrypted License Object passed from the Kiosk Device to the Storage Device at the time a Content file was loaded to the Storage Device. The DRM engine (100) enables a decryption of the License Object with the decryption keys stored in a key vault (200). After the License Object is decrypted, and the DRM engine (100) applies the use parameters from the License Object, streaming of the Content to the Playback Device is initiated from the Content Storage (400) area of the Storage Device. The Storage Device also contains a user profile (300) which is referenced by both Kiosk Devices and Playback Devices whenever the Storage Device is connected to these devices. In the case of the Kiosk Device, the user profile is used to apply predictive algorithms to draw correlations between the data available through the Kiosk Device and the data in the user profile and offer Content that is highly-applicable to the user. In the case of the Playback Device, the user profile is used to create a personalized viewing experience, and to track viewing metrics to further enhance the data in the user profile.

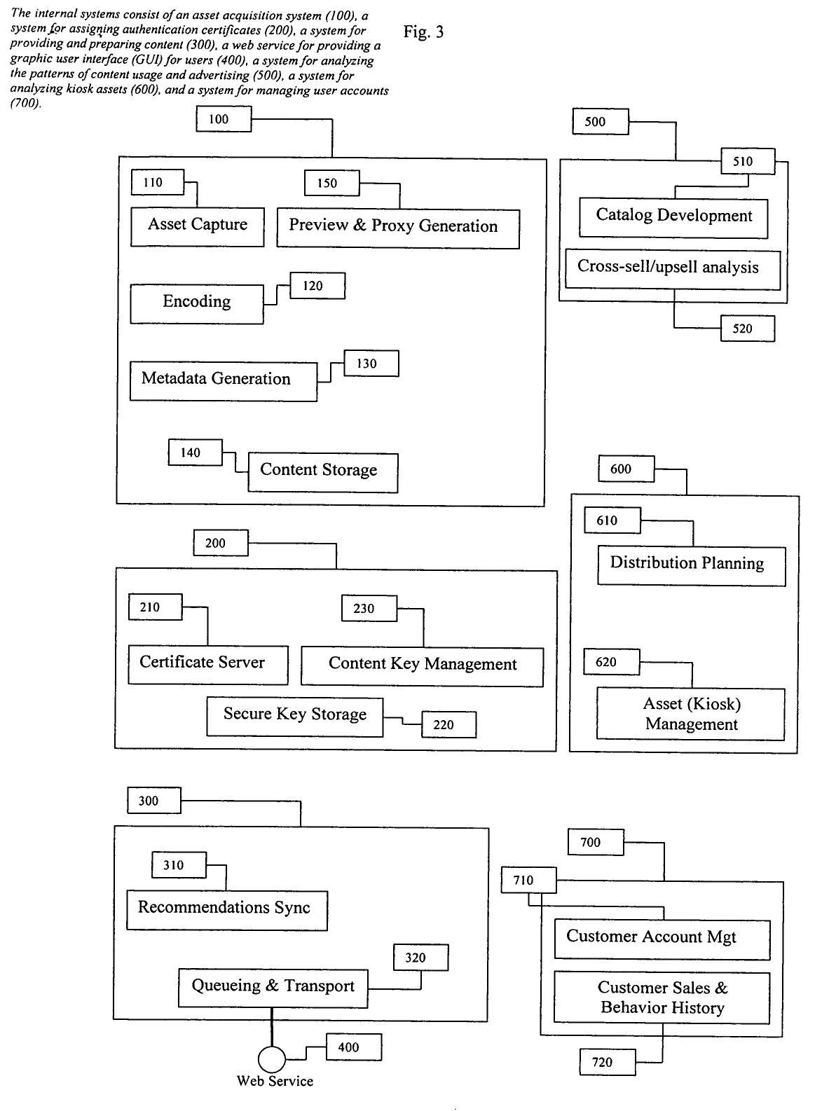

FIG. 3 shows an example of a “head-end” control system used to manage and control an embodiment of the invention. The process begins with the acquisition of Content (100) from studios, distributors, and other Content owners. The Content is then copied into the head-end system (110), where it is encoded (120) into any of a variety of Codecs based on applicable requirements, and encrypted immediately after the encoding process. Meta-data for the Content are gathered or generated and then applied to a meta-data file (130) that accompanies the encrypted Content file. Also accompanying the Content file are trailers of the Content file that are gathered or generated (150) and the stored along with the encrypted Content file in the Content data store (140). The certificate management area (200) generates encryption keys (210) for the Content and stores them in a secure data vault (220). These are packaged with the Content from the Content data store (140) by the Content Key Management engine (230) when a Content file is moved from the Content data store for distribution. Distribution Management (600) determines the need for movement of Content from the Content data store to Drive Arrays, and as Kiosk Devices are scheduled for placement by Distribution Planning (610), Content files are allocated based on metrics developed at Catalog Development (510) by actively observing regional differences in Content file usage. Kiosk Devices are assembled and distributed by Asset Management (620) and moved to their point of install. Based on placement location and the Content files on the Drive Arrays, Merchandising (500) may specify specific Cross-sell and promotional data (520) for specific Kiosk Devices. User accounts are managed by a Customer Resource Management (CRM) area (700) wherein the user accounts are organized and managed (710) and a user-interface for users to manage their accounts is provided. All user interaction with the system is tracked and recorded in a user activity database (720). User-account specific usage data is stored associated with the specific user's account, while aggregated usage data is stored in a central database (720). The head-end communications manager (300) initiates all subroutines queued by the user GUI (400), including the requests for Content files (320) to be prepared and loaded to the Storage Device, and the algorithms (310) for correlating user profile data with available Content.

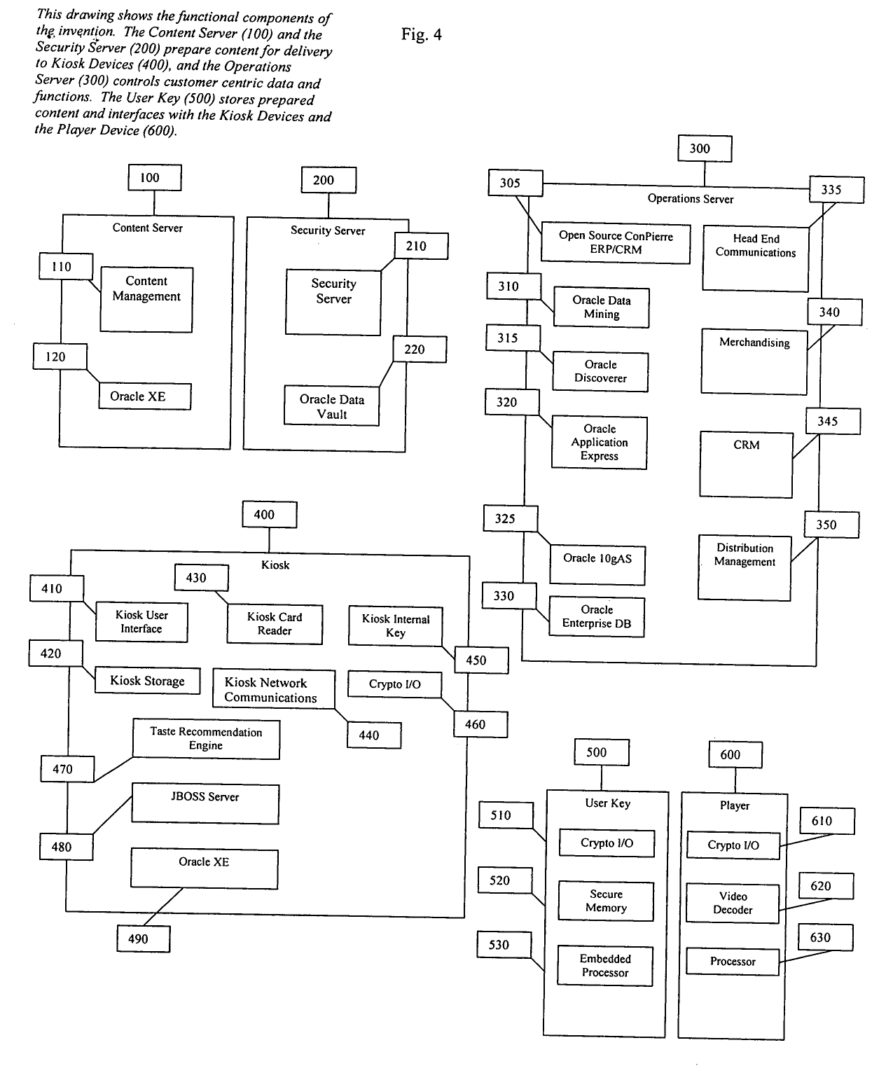

FIG. 4 shows an overview of the functional system associated with an embodiment of the invention. Managed by the head-end are the Content Server (100), the Security Server (200), the Operations Server (300), and the Kiosk Device (400). Managed by both the user and the head-end is the Storage Device (500) and the Playback Device (600). The Content Server (100) is made up of a database of Content (120) that is staged for distribution to Drive Arrays by the Content Manager (110). The Security Server (200) consists of a server that generates and distributes the encryption keys (210) and a secured data vault (220) where the keys are stored. The management of the user and commerce activity is controlled by the Operations Server (300) that manages a suite of physical and software assets. This server manages the user accounts through a CRM application (305), pulls usage data from these accounts (310) and aggregates the data (315) for use by the recommendation engine (470) on the Kiosk Device to make correlations between the user profile data and the available Content on the Drive Arrays. Both front-facing and internal applications are managed by an application development and management suite (320, 325), and the collection, organization, and storage of data is managed by an enterprise database management application (330). The Operations Server (300) manages the communication between the internal applications (305-330) and the front-facing applications (335-350) that directly feed the devices that interface directly with the user (400, 500, 600). The Storage Device (500) connects to the Kiosk Device (400) via a hardware interface which verifies and authenticates the device through the internal hardware key tables (450) and the encryption engines (460), and then the user interacts with both devices via the Kiosk GUI (410). Through GUI, the user may search through the Content library on the Disk Array (420), select Content files for loading to the Storage Device, and make payments with credit or debit cards (430). Upon connection of a Storage Device to the Kiosk Device, the recommendation engine (470) creates a list of suggested Content files, advertisements, promotions, or other data based on correlations between the user profile on the Storage Device and the Content files on the Drive Arrays (420). When the user selects Content files for loading to the Storage Device, the recommendation engine (470), in addition to previously recommended Content, also selects trailers based on the correlations between the user profile and the Content file to be shown and attaches the trailers to the selected Content file. The Kiosk Device application management is done through the application server (480) on board the Kiosk Device, and database management of the Content on the Drive Arrays (420) is managed by an on board database manager (490). The Storage Device (500) manages its authentication with Kiosk Devices (400) and Playback Devices (600) through the encryption I/O (510), and once authenticated with a device, the embedded processor (530) manages the Content and License Objects stored in the secured memory (520). The processor (530) monitors the status of the License Objects in the secure memory (520) and at the expiration of a License Object, it completes an erasure of the sectors of the secure memory (520) containing the Content to which the expired License Object was associated. The Playback Device (600) manages the authentication process for Storage Devices connecting to it through its encryption I/O (610), and once authenticated with a Storage Device, the processor (630) manages the decryption of the License Objects for Content files selected for playback through the encryption I/O (610). Once the License Object is decrypted, the processor (630) applies the use parameters for the Content file to be viewed, and then initiates the streaming of the Content file from the Storage Device (500), manages the decryption of the data stream through the encryption I/O (610), and then through the video decoder (620) to the output and viewing screen. The viewing screen may be any compatible viewing screen, including, but not limited to a television, LCD panel, plasma screen, monitor, projection system, or any other viewing device that is compatible, or may become compatible with the Playback Device (600).

The preceding describes systems and methods for the storage, transport, and viewing of video, audio, multi-media, or other data using non-volatile storage media. Although the invention has been described with respect to certain example embodiments, it will be apparent to those skilled in the art that the present invention is not limited to these specific embodiments. Further, although the operation of certain embodiments has been described in detail using certain detailed process steps, some of the steps may be omitted, the steps may be performed in different sequences, or other similar steps may be substituted without departing from the scope of the invention. Other embodiments incorporating the inventive features of the invention will be apparent to those skilled in the art.

What is claimed is:

1. A system for distributing data comprising:
(a) a network of freestanding, affixed, and/or integrated kiosk devices (Kiosk Device) with an independent, on-board drive array or arrays, and/or a Local Area Network-connected drive array or arrays, and/or other large capacity data storage memory structures (Drive Arrays);
(b) a portable, processor-enabled, non-volatile memory storage device (Storage Device) used to store and transport Content;
(c) a processor-enabled playback device (Playback Device) which interfaces with the Storage Device to view Content stored on the Storage Device.

2. The system of claim 1 wherein any Storage Device is compatible with any Kiosk Device and any Playback Device.

3. The system of claim 1 wherein the Content is loaded to Drive Arrays which are installed in Kiosk Devices.

4. The system of claim 1 wherein the Content is loaded to Drive Arrays which are installed in central “server rooms” and are then connected to one or more Kiosk Devices via a Local Area Network (LAN).

5. The system of claim 1 wherein the Content is loaded to Drive Arrays which are installed in regional data centers and are then connected to one or more Kiosk Devices via the Internet.

6. The system of claim 1 wherein the Kiosk Device is comprised of a kiosk of different manufacture and/or purpose that has been fitted with the hardware and software necessary to provide the functionalities of the Kiosk Device of this invention.

7. The system of claim 1 wherein the Storage Device is assigned to a user account setup by the owner of the Storage Device.

8. The system of claim 1 wherein the Storage Device is assigned to a user group within the user account setup by the owner of the Storage Device.

9. The system of claim 1 wherein a user interfaces the Storage Device with a Kiosk Device via a hardware interface for the purpose of loading Content to the Storage Device.

10. The system of claim 1 wherein the Kiosk Device validates the authenticity of the Storage Device after a user docks the Storage Device in the hardware interface.

11. The system of claim 1 wherein the Kiosk Device provides a human interface device to the user for the purpose of manipulating the Kiosk Device Graphic User Interface (GUI).

12. The system of claim 1 wherein the Kiosk Device GUI provides a search and sorting method for the user to effectively navigate and select from the Content stored on the Drive Arrays.

13. The system of claim 1 wherein the Kiosk Device GUI provides a venue for requesting a Content file not found on the Drive Arrays.

14. The system of claim 1 wherein the head-end sends notification to the requesting user once the Content file has been delivered to the Kiosk specified by the requesting user.

15. The system of claim 1 wherein the encryption keys are shared between the Kiosk Device and the Storage Device via a secured link and stored in the secured FPGA on board the Storage Device.

16. The system of claim 1 wherein the Storage Device is of varying memory capacities based on the intended application, user, market, and other variables both currently anticipated and yet to be anticipated.

17. The system of claim 1 wherein the Playback Device is assigned to a user account setup by the owner of the Playback Device.

18. The system of claim 1 wherein the Playback Device is assigned to a user group within the user account setup by the owner of the Playback Device.

19. The system of claim 1 wherein the Playback Device is embedded within a viewing device including but not limited to Televisions, LCD panels, Plasma screens, projection screens, monitors, and any other viewing screen that may become compatible with an embedded Playback Device.

20. The system of claim 1 wherein the Playback Device validates the authenticity of the Storage Device after a user docks the Storage Device in the hardware interface.

21. The system of claim 1 wherein the Playback Device validates the encryption keys of the License Object file and Content file prior to streaming the data from the Storage Device.

22. The system of claim 1 wherein the Playback Device connects to a variety of viewing screens, including but not limited to Televisions, LCD panels, Plasma screens, projection screens, monitors, and any other viewing screen that is, or may become compatible with the Playback Device.

23. A method for distributing data comprising:
(a) a method for creating a central repository of data, and for distributing that data to users of the distribution system.
(b) a method for assigning a variety of use parameters to data being distributed to users of the distribution system.
(c) A method for establishing user accounts for users of the distribution system and associating components of the distribution system to the user accounts.
(d) A method for tracking user interaction with the distribution system to create a user profile data file.
(e) A method for making correlations between the data in a user profile and the available data in the distribution system.

24. The method of claim 23 storing and aggregating Content into a central repository.

25. The method of claim 23 encrypting the Content during the aggregation process into the central repository.

26. The method of claim 23 wherein upon acquisition of a Storage Device and/or Playback Device, the user sets up a user account and defines the initial parameters of the user profile including but not limited to: favorite genres, actors, directors, eras, age, gender, interests, and/or any other parameters that are, or may be included in the user profile.

27. The system of claim 26 storing encryption keys inside secured Field Programmable Gate Arrays (FPGA) on board the Storage Device.

28. The method of claim 23 collecting and aggregating data associated with the usage of the Storage Device, viewing of Content files, usage of the Kiosk Device, and/or all other interactions with the system in the user account to continually evolve and/or expand the user profile.

29. The method of claim 23 assigning the Storage Device is assigned use parameters in the user account by the owner of the Storage Device and/or defining use parameters, including but not limited to: ratings, genres, spending limits, and/or other use parameters available to the Storage Device.

30. The method of claim 23 wherein the Kiosk Device accesses a user profile data file contained on the Storage Device determining correlations between the data in the user profile and available Content, movie trailers, advertisements, promotions, and other data applicable to the user profile.

31. The method of claim 30 defining the correlations between the data in the user profile and available Content, movie trailers, advertisements, promotions, and other data applicable to the user profile by the Content file chosen for loading to the Storage Device.

32. The method of claim 30 further defining the correlations between the data in the user profile and available Content, movie trailers, advertisements, promotions, and other data applicable to the user profile by the physical location of the Kiosk Device.

33. The method of claim 23 generating the Kiosk Device license object files (License Object) during the loading of files to a Storage Device, thereby defining the viewing parameters and permissions for Content files.

34. The method of claim 33 wherein the Kiosk Device assigns a License Object to a Content file being loaded to the Storage Device.

35. The method of claim 33 wherein the Kiosk Device encrypts the License Object to be loaded to the Storage Device.

36. The method of claim 33 wherein the Kiosk Device internally generates encryption keys for the License Objects.

37. The method of claim 23 wherein a user may remove a Content file from the Storage Device to make room for additional Content files while retaining an active License Object for that Content file in the user account.

38. The method of claim 37 wherein a user may delete a Content file from the Storage Device while connected into the interface of a Kiosk Device.

39. The method of claim 37 wherein a user may delete a Content file from the Storage Device while connected into the interface of a Playback Device.

40. The method of claim 37 wherein a user may initiate the deletion of a Content file from the Storage Device while accessing the user account from a personal computer.

41. The method of claim 23 wherein a user may move active License Objects for Content files not stored on the Storage Device from the user account to the Storage Device.

42. The method of claim 41 wherein a user may move active License Objects for Content files not stored on the Storage Device from the user account, and the associated Content files from the Drive Arrays to the Storage Device while the Storage Device is connected into the interface of a Kiosk Device.

43. The method of claim 41 wherein a user may move active License Objects for Content files not stored on the Storage Device from the user account to the Storage Device, and initiate the transfer of the associated Content file to the Storage Device while accessing the user account from a personal computer.

44. The method of claim 41 wherein a user may move active License Objects for Content files not stored on the Storage Device from the user account to the Storage Device, and initiate the transfer of the associated Content file to the Storage Device while the Storage Device is connected into the interface of a Playback Device.

45. The method of claim 40 deleting the Content file associated with the deleted License Object from the Storage Device at the next instance where the Storage Device is connected to a Kiosk Device.

46. The method of claim 44 adding the Content file associated with the added License Object to the Storage Device at the next instance where the Storage Device is connected to a Kiosk Device.

47. The method of claim 44 adding the Content file associated with the added License Object to the Storage Device while the Storage Device is connected into the interface of a Playback Device when the Playback Device is enabled with the functionality of a Kiosk Device.

48. The method of claim 47 assigning a stored monetary value to a file within the Storage Device.

49. The method of claim 23 assigning a stored monetary value to a file within the Storage Device while the Storage Device is connected to a Kiosk Device and payment for the stored monetary value is paid for through an online or physical payment method at the Kiosk Device.

50. The method of claim 23 assigning a stored monetary value to a file within the Storage Device while the Storage Device is connected to a Playback Device and payment for the stored monetary value is paid for through an online payment method stored in the user account.

51. The method of claim 23 wherein the Playback Device is assigned use parameters in the user account by the owner of the Playback Device defining use parameters including, but not limited to ratings, genres, spending limits, and other use parameters available through the Playback Device.

52. The method of claim 23 wherein the Playback Device accesses a user profile data file contained on the Storage Device when the Storage Device is connected to the Playback Device and modifies the GUI to accommodate the user profile data including, but not limited to user name, available ratings, genres, available promotions, advertisements, or other parameters applicable to the user profile.

53. The method of claim 23 wherein the Playback Device decrypts the License Object file and applies the use parameters and permissions to the Content file.

54. The method of claim 23 wherein the Playback Device decrypts the Content file as it streams from the Storage Device for viewing via the Playback Device.

55. The method of claim 23 wherein if a Storage Device is removed from the Playback Device in the middle of viewing a Content file, the Playback Device records to the Storage Device the frame-set of the Content file where the viewing session was interrupted.

56. The method of claim 55 wherein the Storage Device starts the interrupted viewing session of the Content file some number of frames prior to the point at which it was interrupted ensuring that the user doesn't miss any of the Content.

57. The method of claim 23 wherein the Playback Device displays a menu of options at the conclusion of the viewing of a Content file offering options including but not limited to extending a temporary License Object, converting a temporary License Object to a permanent License Object, obtaining License Objects for similar or serialized Content, leaving feedback to an online community regarding the Content, and any other menu options that may be developed and implemented.

58. The method of claim 23 wherein at the time of expiration of a License Object, the processor on board the Storage Device reformats the sectors of the memory containing the corresponding Content file thus completely deleting the Content from the Storage Device.
